(19) United States
(12) Patent Application Publication
(10) Pub. No.: US 2024/0199087 A1
(43) Pub. Date: Jun. 20, 2024

(54) VEHICLE CONTROL DEVICE AND VEHICLE CONTROL METHOD

(71) Applicant: DENSO CORPORATION, Kariya-city (JP)

(72) Inventors: Takuya KUME, Kariya-city (JP); Kazuki IZUMI, Kariya-city (JP)

(21) Appl. No.: 18/430,552

(22) Filed: Feb. 1, 2024

Related U.S. Application Data
(63) Continuation of application No. PCT/JP22/27872, filed on Jul. 15, 2022.

(30) Foreign Application Priority Data
Aug. 5, 2021 (JP) 2021-129222

(51) Int. Cl. B60W 60/00; G08G 1/01

(52) U.S. Cl. CPC B60W 60/005; G08G 1/0112; G08G 1/0133; G08G 1/0145; B60W 2552/20; B60W 2554/4042; B60W 2554/406

(57) ABSTRACT

A technique controls a subject vehicle that executes congestion automated driving permitted in traffic congestion. Traffic congestion is determined based on a speed of the subject vehicle. Execution and non-execution of the congestion automated driving are switched in accordance with a determination result of the traffic congestion. The traffic congestion may be determined to be present on conditions that (i) a road type of a road on which the subject vehicle travels is a specific road type in which the congestion automated driving is permitted, (ii) there is at least one surrounding vehicle including a preceding vehicle ahead of the subject vehicle, and (iii) a situation in which the speed of the subject vehicle is equal to or less than a predetermined speed has continued for a first predetermined time or more.

### CROSS REFERENCE TO RELATED APPLICATIONS

The present application is a continuation application of International Patent Application No. PCT/JP2022/027872 filed on Jul. 15, 2022, which designated the U.S. and claims the benefit of priority from Japanese Patent Application No. 2021-129222 filed on Aug. 5, 2021. The entire disclosures of all of the above applications are incorporated herein by reference.

### TECHNICAL FIELD

The present disclosure relates to a vehicle control device and vehicle control method.

### BACKGROUND

A technique determines that traffic congestion is present and initiating automated driving in response to the presence of traffic congestion.

### SUMMARY

According to at least one embodiment of the present disclosure, a technique controls a subject vehicle configured to execute congestion automated driving. The congestion automated driving is automated driving permitted in traffic congestion. The traffic congestion is determined based on a speed of the subject vehicle used as a condition, and execution and non-execution of the congestion automated driving are switched in accordance with a determination result. The traffic congestion may be determined to be present on conditions including a condition that a road type of a road on which the subject vehicle travels is a specific road type in which the congestion automated driving is permitted, a condition that there is at least one surrounding vehicle including a preceding vehicle ahead of the subject vehicle, and a condition that a situation in which the speed of the subject vehicle is equal to or less than a predetermined speed has continued for a first predetermined time or more. The traffic congestion may be determined to be absent on a condition that the situation in which the speed of the vehicle is equal to or less than the predetermined speed has not continued for the first predetermined time.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a schematic diagram illustrating a configuration of a vehicle system.

FIG. 2 is a diagram illustrating an example of a schematic configuration of an automated driving ECU.

FIG. 3 is a flowchart illustrating an example of a flow of a congestion determination-related process in the automated driving ECU.

FIG. 4 is a flowchart illustrating an example of a flow of a LV3 determination process in the automated driving ECU.

FIG. 5 is a flowchart illustrating an example of a flow of a LV2 determination

process in the automated driving ECU.

### DETAILED DESCRIPTION

A comparative example will be described. A technique according to the comparative example determines that traffic congestion is present and initiates automated driving in response to the presence of traffic congestion. The presence of traffic congestion is determined on condition that a vehicle speed is 5 km/h or less.

However, when the vehicle is traveling, the vehicle speed may temporarily change greatly. Therefore, in the technique of the comparative example, the temporary change in vehicle speed may lead to determination that traffic congestion is present.

In contrast, according to the present disclosure, a vehicle control device and a vehicle control method are capable of accurately determining presence of traffic congestion that is a condition for automated driving.

According to a first aspect of the present disclosure, a vehicle control device is configured to be used in a subject vehicle configured to execute congestion automated driving. The congestion automated driving is automated driving permitted in traffic congestion. The vehicle control device includes a congestion determination unit configured to determine traffic congestion based on a speed of the subject vehicle used as a condition, and a switching unit configured to switch between execution and non-execution of the congestion automated driving in accordance with a determination result of the congestion determination unit. The congestion determination unit is further configured to determine that traffic congestion is present on conditions including a condition that a road type of a road on which the subject vehicle travels is a specific road type in which the congestion automated driving is permitted, a condition that there is at least one surrounding vehicle including a preceding vehicle ahead of the subject vehicle, and a condition that a situation in which the speed of the subject vehicle is equal to or less than a predetermined speed has continued for a first predetermined time or more.

According to a second aspect of the present disclosure, a vehicle control method is used in a subject vehicle configured to execute congestion automated driving and executed by at least one processor. The congestion automated driving is automated driving permitted in traffic congestion. The method includes determining traffic congestion based on a speed of the subject vehicle used as a condition, and switching between execution and non-execution of the congestion automated driving in accordance with a determination result of the determining. The determining includes determining that traffic congestion is present on conditions including a condition that a road type of a road on which the subject vehicle travels is a specific road type in which the congestion automated driving is permitted, a condition that there is at least one surrounding vehicle including a preceding vehicle ahead of the subject vehicle, and a condition that a situation in which the speed of the subject vehicle is equal to or less than a predetermined speed has continued for a first predetermined time or more.

According to the above configuration, traffic congestion is determined based on the fact that the situation in which the speed of the subject vehicle is equal to or less than the predetermined speed has continued for the first predetermined time or more. Therefore, it is possible to prevent a temporary change in the vehicle speed from causing determination that traffic congestion is present. In addition, the traffic congestion is determined based also on the fact that the road type of the road on which the subject vehicle travels is the specific road type in which the congestion automated driving is permitted. Therefore, a non-congestion situation is less likely to be erroneously determined as traffic congestion. Further, the traffic congestion is determined based on the presence of the surrounding vehicle including at least the preceding vehicle ahead of the subject vehicle. Therefore, a non-congestion situation is less likely to be erroneously determined as traffic congestion also in this respect. As a result, it is possible to more accurately determine the traffic congestion which is the condition of the automated driving.

According to a third aspect of the present disclosure, a vehicle control device is configured to be used in a subject vehicle configured to execute congestion automated driving. The congestion automated driving is automated driving permitted in traffic congestion. The vehicle control device includes a congestion determination unit configured to determine traffic congestion based on a speed of the subject vehicle used as a condition, and a switching unit configured to switch between execution and non-execution of the congestion automated driving in accordance with a determination result of the congestion determination unit. The congestion determination unit is further configured to determine that traffic congestion is absent on a condition that a situation in which the speed of the vehicle is equal to or less than a predetermined speed has not continued for a first predetermined time.

According to a fourth aspect of the present disclosure, a vehicle control method is used in a subject vehicle configured to execute congestion automated driving and executed by at least one processor. The congestion automated driving is automated driving permitted in traffic congestion. The method includes determining traffic congestion based on a speed of the subject vehicle used as a condition, and switching between execution and non-execution of the congestion automated driving in accordance with a determination result of the determining. The determining includes determining that traffic congestion is absent on a condition that a situation in which the speed of the vehicle is equal to or less than a predetermined speed has not continued for a first predetermined time.

According to the above configuration, absence of traffic congestion is determined based on the fact that the situation in which the speed of the subject vehicle is equal to or less than the predetermined speed has not continued for the first predetermined time. Therefore, it is possible to prevent a temporary change in the vehicle speed from causing determination that traffic congestion is present. As a result, it is possible to more accurately determine the traffic congestion which is the condition of the automated driving.

Multiple embodiments will be described with reference to the drawings. For convenience of explanation, portions having the same functions as those illustrated in the drawings used in the description among embodiments are assigned the same reference symbol, and descriptions of the same portions may be omitted. Descriptions in another embodiment may be applied for the portions assigned the same reference symbol.

### First Embodiment

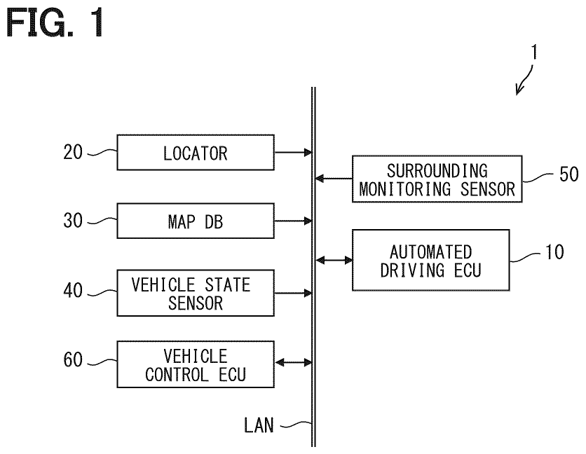

Hereinafter, a first embodiment of the present disclosure will be described with reference to the drawings. A vehicle system 1 shown in FIG. 1 can be used for a vehicle configured to execute automated driving. Hereinafter, the vehicle may be referred to as an automated driving vehicle. As illustrated in FIG. 1, the vehicle system 1 includes an automated driving ECU 10, a locator 20, a map database (hereinafter, referred to as map DB) 30, a vehicle state sensor 40, a surrounding monitoring sensor 50, and a vehicle control ECU 60. For example, the automated driving ECU 10, the locator 20, the map DB 30, the vehicle state sensor 40, the surrounding monitoring sensor 50, and the vehicle control ECU 60 may be connected to an in-vehicle LAN (see “LAN” in FIG. 1). Although the vehicle including the vehicle system 1 is not necessarily limited to an automobile, a case where the vehicle system 1 is used in an automobile will be described below as an example.

The stages of the automated driving (hereinafter, referred to as an automation level) of the automated driving vehicle includes multiple levels as defined by, for example, SAE. This automation level is classified into, for example, five levels including LV0 to LV5 as follows.

LV0 is a level where a driver performs all driving tasks without intervention of the system. The driving task may be rephrased as a dynamic driving task. The driving task includes, for example, steering, acceleration/deceleration, and surrounding monitoring. LV 0 corresponds to so-called manual driving. LV 1 is a level where the system assists either steering or acceleration/deceleration. LV 1 corresponds to so-called driving assistance. LV 2 is a level where the system assists both steering and acceleration/deceleration. LV 2 corresponds to so-called partial driving automation. The automated driving at LV2 includes automated driving at congestion-only LV2 permitted in traffic congestion. The automated driving at the congestion-only LV2 corresponds to congestion automated driving with a monitoring obligation. Hereinafter, an example where the automated driving at LV2 is the automated driving of at the congestion-only LV2 will be described. LV1 and LV2 are also part of automated driving.

For example, the automated driving at LVs 1 and 2 is automated driving in which a driver has an obligation of monitoring related to safe driving. Hereinafter, the obligation is simply referred to as a monitoring obligation. That is, this corresponds to automated driving with the monitoring obligation. The monitoring obligation includes visual monitoring of the surroundings of the vehicle. The automated driving at LVs 1 and 2 is, in other words, automated driving in which a second task is not permitted. The second task is an action permitted to the driver other than a driving operation, and is a predetermined specific action. The second task can also be rephrased as a secondary activity, another activity, or the like. The second task must not prevent the driver from responding to a request to take over a driving operation from an automated driving system. As an example, viewing of a content such as a video, operation of a smartphone, reading, and eating are assumed as the second task.

LV 3 of the automated driving is a level where the system executes all driving tasks under certain conditions, and the driver performs the driving operation in case of emergency. In the automated driving at LV3, it is required that the driver can quickly respond to a request of driving takeover from the system. The driving takeover can also be reworded as transfer of the surrounding monitoring obligation from the vehicle system to the driver. LV3 corresponds to so-called conditional driving automation. The LV 3 includes an area-limited LV3 limited to a specific area. The specific area described here may be a road exclusive for automobiles or an expressway. The specific area may be, for example, a specific lane. LV3 also includes a congestion-only LV3 that is limited to traffic congestion. The congestion-only LV 3 may be limited to traffic congestion in, for example, the road for automobiles, and the expressway. The automated driving at the congestion-only LV3 corresponds to congestion automated driving without the monitoring obligation. Both the automated driving at the congestion-only LV2 and the automated driving at the congestion-only LV3 correspond to congestion automated driving.

LV 4 of the automated driving is a level where the system is capable of executing all driving tasks, except under a specific circumstance, such as an unexpected road condition, an extreme environment, and the like. LV 4 corresponds to a high driving automation. LV 5 of the automated driving is a level in which the system is capable of executing all driving tasks in any situation. LV 5 corresponds to a full driving automation.

For example, the automated driving at LVs 3 to 5 is an automated driving in which the driver does not have the monitoring obligation. In other words, the automated driving corresponds to automated driving without the monitoring obligation. The automated driving at LVs 3 to 5 can be rephrased as automated driving in which the second task is permitted. Among the automated driving at LV3 to LV5, the automated driving at LV4 or higher corresponds to the automated driving in which sleeping of the driver is permitted. Among the automated driving of LV3 to LV5, the automated driving at LV3 corresponds to automated driving in which sleeping of the driver is not permitted.

The automated driving vehicle of the present embodiment is capable of switching the automation level. The automation level may be switchable only between some levels of the LVs 0 to 5. In the present embodiment, a case where the automated driving vehicle can switch at least between the automated driving of at the congestion-only LV3, the automated driving at the congestion-only LV2, and manual driving at LV0 will be described as an example.

The locator 20 includes a GNSS (Global Navigation Satellite System) receiver and an inertial sensor. The GNSS receiver is configured to receive positioning signals from multiple positioning satellites. The inertial sensor includes a gyro sensor and an acceleration sensor, for example. The locator 20 combines the positioning signals received by the GNSS receiver with the measurement results of the inertial sensor so as to sequentially detect the position of the subject vehicle (hereinafter, subject vehicle position) on which the locator 20 is mounted. The subject vehicle position may be represented by, for example, coordinates of latitude and longitude. The subject vehicle position may be measured based on also a travel distance obtained from signals sequentially output from a vehicle speed sensor mounted in the vehicle.

The map DB 30 is a non-volatile memory and stores high-definition map data. The high-definition map data is map data with higher precision than the map data used for route guidance in a navigation function. The map DB 30 may also store map data used for route guidance. The high-definition map data includes information that can be used for the automated driving operation, such as three-dimensional road shape information, information on the number of lanes, and information indicating the direction of travel for each lane. In addition, the high-definition map data may also include, for example, a node point information indicating the positions of both ends of a road marking such as a lane marking. The locator 20 may be configured not to use the GNSS receiver by using the three-dimensional shape information of the road. For example, the locator 20 may determine the subject vehicle position by using the three-dimensional shape information of the road and a detection result of the surrounding monitoring sensor 50 such as a surrounding monitoring camera or a LiDAR (Light Detection and Ranging/Laser Imaging Detection and Ranging) that detects feature points of the road shape and the structure. The three-dimensional shape information of the road may be generated based on a captured image by REM (Road Experience Management).

Map data distributed from an external server distributed through, for example, wide area communications may be received by a communication module and stored in the map DB 30. In this case, the map DB 30 may be a volatile memory, and the communication module may sequentially acquire map data of an area corresponding to the subject vehicle position.

The vehicle state sensor 40 is a sensor group for detecting various states of the subject vehicle. Examples of the vehicle state sensor 40 include a vehicle speed sensor that detects a vehicle speed as a speed of the subject vehicle. The vehicle state sensor 40 outputs detected sensing information to the in-vehicle LAN. The sensing information detected by the vehicle state sensor 40 may be output to the in-vehicle LAN via an ECU mounted on the subject vehicle.

The surrounding monitoring sensor 50 monitors a surrounding environment of the subject vehicle. For example, the surrounding monitoring sensor 50 detects obstacles around the subject vehicle such as moving objects such as pedestrians and other vehicles, and stationary objects such as fallen objects on the road. In addition, a road marking such as a traveling lane marking around the subject vehicle is detected. The surrounding monitoring sensor 50 is a sensor such as a surrounding monitoring camera that captures a predetermined range around the subject vehicle, a millimeter wave radar that transmits a search wave in a predetermined range around the subject vehicle, a sonar, or a LiDAR. The surrounding monitoring camera sequentially outputs, as sensing information, sequentially captured images to the automated driving ECU 10. A sensor that transmits a probe wave, such as the sonar, the millimeter wave radar or the LiDAR, sequentially outputs the sensing information to the automated driving ECU 10, and the sensing information is a scanning result based on a received signal acquired as a wave reflected from an obstacle on the road. The sensing information detected by the surrounding monitoring sensor 50 may be output to the automated driving ECU 10 without passing through the in-vehicle LAN.

The vehicle control ECU 60 is an electronic control unit that executes traveling control of the subject vehicle. The traveling control includes an acceleration/deceleration control and/or a steering control. The vehicle control ECU 60 includes a steering ECU that executes the steering control, a power unit control ECU and a brake ECU that execute the acceleration/deceleration control. The vehicle control ECU 60 is configured to output a control signal to a traveling control device such as an electronic throttle, a brake actuator, and an EPS (Electric Power Steering) motor mounted on the subject vehicle, thereby executing the traveling control.

The automated driving ECU 10 mainly includes a computer including a processor, a volatile memory, a nonvolatile memory, an I/O, and a bus connecting these devices. The automated driving ECU 10 executes processing related to automated driving by executing a control program stored in the nonvolatile memory. The automated driving ECU 10 corresponds to a vehicle control device. The configuration of the automated driving ECU 10 will be described in detail below.

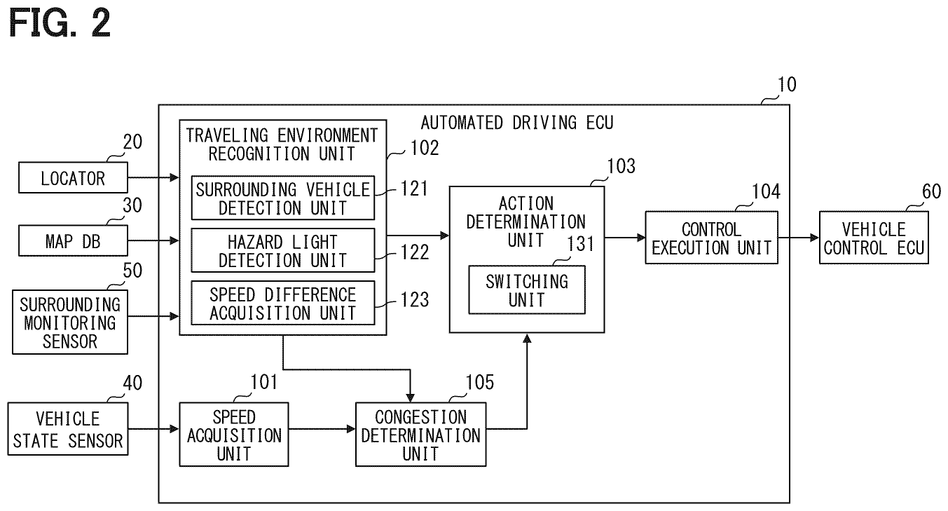

Next, the configuration of the automated driving ECU 10 will be described with reference to FIG. 2. As illustrated in FIG. 2, the automated driving ECU 10 includes a speed acquisition unit 101, a traveling environment recognition unit 102, an action determination unit 103, a control execution unit 104, and a congestion determination unit 105 as functional blocks. The execution of processes of the functional blocks of the automated driving ECU 10 by the computer corresponds to execution of a vehicle control method. Some or all of the functions executed by the automated driving ECU 10 may be implemented as hardware with one or more ICs or the like. Some or all of the functional blocks included in the automated driving ECU 10 may be implemented by a combination of execution of software by a processor and a hardware member.

The speed acquisition unit 101 acquires the speed of the subject vehicle, i.e., specifies the speed of the subject vehicle. The speed acquisition unit 101 acquires the speed of the subject vehicle from the vehicle speed detected by the vehicle speed sensor included in the vehicle state sensor 40.

The traveling environment recognition unit 102 recognizes a travel environment of the subject vehicle from the subject vehicle position acquired from the locator 20, the map data acquired from the map DB 30, and the sensing information acquired from the surrounding monitoring sensor 50. For example, the traveling environment recognition unit 102 utilizes these pieces of information to recognize a position, a shape, and a movement state of an object around the subject vehicle, and generates a virtual space in which an actual traveling environment is reproduced. The traveling environment recognition unit 102 may recognize a surrounding vehicle that is a vehicle around the subject vehicle from the sensing information acquired from the surrounding monitoring sensor 50. More specifically, the traveling environment recognition unit 102 may recognize presence of the surrounding vehicle, a relative position of the surrounding vehicle relative to the subject vehicle, a relative speed of the surrounding vehicle relative to the subject vehicle, and the like as the traveling environment. In a case where position information, speed information, and the like of the surrounding vehicle can be acquired via the communication module, the traveling environment may be recognized using these pieces of information.

The traveling environment recognition unit 102 includes a surrounding vehicle detection unit 121, a hazard light detection unit 122, and a speed difference acquisition unit 123 as sub-functional blocks. The surrounding vehicle detection unit 121 detects (i.e., specifies) the presence of the surrounding vehicle around the subject vehicle. The surrounding vehicle detection unit 121 detects presence of at least one of a following vehicle, a side vehicle and a preceding vehicle. The following vehicle is a vehicle following the subject vehicle on a directly rear side of the subject vehicle. The side vehicle is a vehicle positioned on a lateral side of the subject vehicle. The preceding vehicle is a vehicle preceding the subject vehicle on a directly front side of the subject vehicle. In the present embodiment, a case where the presence of any of the preceding vehicle ahead of the subject vehicle, the following vehicle behind the subject vehicle, and the side vehicle beside the subject vehicle can be identified will be described as an example.

The surrounding vehicle detection unit 121 may detect presence of the preceding vehicle, for example, when a vehicle is present ahead of the subject vehicle and a position of the vehicle relative to the subject vehicle is within a predetermined distance. The surrounding vehicle detection unit 121 may detect presence of the following vehicle, for example, when a vehicle is present behind the subject vehicle and a position of the vehicle relative to the subject vehicle is within a predetermined distance. The surrounding vehicle detection unit 121 may detect presence of the side vehicle, for example, when a vehicle is present on a lateral side of the subject vehicle and a position of the vehicle relative to the subject vehicle is within a predetermined distance. The side vehicle may be rephrased as a parallel traveling vehicle running in parallel with the subject vehicle. The parallel traveling vehicles may be vehicles located on left or right sides of the subject vehicle in an adjacent lane having the same traveling direction as the traveling lane of the subject vehicle. The predetermined distance mentioned here may be a value that can be arbitrarily set. Here, the predetermined distance may be a different value for each of the preceding vehicle, the following vehicle, and the side vehicle.

The hazard light detection unit 122 detects lighting of a hazard light of the preceding vehicle in front of the subject vehicle. The hazard light detection unit 122 may detect lighting of the hazard light of the preceding vehicle by, for example, image recognition on a captured image of the preceding vehicle captured by the surrounding monitoring camera of the surrounding monitoring sensor 50. In addition, when the hazard light detection unit 122 can acquire information on the lighting state of the hazard light from the preceding vehicle via the communication module, the hazard light detection unit 122 may detect the lighting of the hazard light of the preceding vehicle from the information on the lighting state.

The speed difference acquisition unit 123 acquires (i.e., specifies) a speed difference between the subject vehicle and the surrounding vehicle whose presence has been detected by the surrounding vehicle detection unit 121. The speed difference acquisition unit 123 may acquire, for example, a relative speed of the surrounding vehicle recognized by the traveling environment recognition unit 102 as the speed difference between the surrounding vehicle and the subject vehicle.

The traveling environment recognition unit 102 may also determine a manual driving area (hereinafter, referred to as an MD area) in a traveling area of the subject vehicle. The traveling environment recognition unit 102 may also determine an automated driving area (hereinafter, referred to as an AD area) in the traveling area of the subject vehicle. The traveling environment recognition unit 102 may also determine an ST section and a non-ST section, which will be described later, in the AD area.

The MD area is an area where the automated driving is prohibited. In other words, the MD area is an area where the driver performs all of a longitudinal control of the subject vehicle in a longitudinal direction, a lateral control of the subject vehicle in a lateral direction, and surrounding monitoring of the subject vehicle. The longitudinal direction is a direction that coincides with a front-rear direction of the subject vehicle. The lateral direction is a direction that coincides with a right-left direction of the subject vehicle. The longitudinal control corresponds to acceleration-deceleration control of the subject vehicle. The lateral control corresponds to steering control of the subject vehicle. For example, the MD area may be a general road.

The AD area is an area where automated driving is permitted. In other words, the AD area is an area defined such that the subject vehicle can substitute for one or more of the longitudinal control, the lateral control, and the surrounding monitoring. For example, the AD area may be the expressway or the automobile road. It is assumed that the automated driving at the congestion-only LV2 and the congestion-only LV3 is permitted only in traffic congestion in the AD area.

The AD area is divided into an ST section and a non-ST section. The ST section is a section in which the automated driving at the area-limited LV3 (hereinafter, referred to as area-limited automated driving) is permitted. The area-limited automated driving may be configured to be permitted only in specific lanes in the ST section. The non-ST section is a section in which automated driving at LV2 or less and automated driving at congestion-only LV3 are possible. In the present embodiment, the non-ST section in which the automated driving at LV1 is permitted and the non-ST section in which the automated driving at LV2 is permitted are not divided. The ST section may be, for example, a traveling section in which high-definition map data is prepared. The non-ST section may be set to a section that does not correspond to the ST section in the AD area.

The action determination unit 103 switches a control subject of a driving operation of the subject vehicle between the driver and the system of the subject vehicle. The action determination unit 103 determines a traveling plan to travel the subject vehicle based on the recognition result of the traveling environment by the traveling environment recognition unit 102 when the system has a right to control the driving operation. The travel plan may be determined as a behavior to be taken by the subject vehicle in order to arrive at a destination.

The action determination unit 103 includes a switching unit 131 as a sub-functional block. The switching unit 131 switches the automation level of the automated driving of the subject vehicle as necessary. The switching unit 131 may increase the automation level to a higher automation level when the condition of the higher automation level is satisfied. When the condition of the automation level being implemented is no longer satisfied, the switching unit 131 may lower the automation level to an automation level whose condition is satisfied.

The switching unit 131 switches whether to execute the congestion automated driving in accordance with a determination result of the congestion determination unit 105 described later. The process in the switching unit 131 corresponds to a switching step. The switching unit 131 may switch the automation level to the congestion-only LV3 when the automation level is equal to or lower than LV2 and a condition of traffic congestion determination for the congestion-only LV3 is satisfied. The switching unit 131 may switch the automation level to the congestion-only LV2 when the automation level is equal to or lower than LV1 and a condition of traffic congestion determination for the congestion-only LV2 is satisfied. The switching unit 131 may switch the automation level to LV2 or lower when the automation level is the congestion-only LV3 and a condition of the traffic congestion determination for the congestion-only LV3 is not satisfied. Here, when the condition of the congestion determination for the congestion-only LV2 is satisfied, the automation level may be switched to the congestion-only LV2. The switching unit 131 may switch the automation level to LV1 or lower when the automation level is the congestion-only LV2 and the condition of the traffic congestion determination for the congestion-only LV2 is not satisfied.

The switching unit 131 may switch between an automation level other than the area-limited LV3 and the area-limited LV3 depending on whether the subject vehicle is located in the ST section of the AD area. In addition, the switching unit 131 may be configured to execute switching to increase the automation level on the condition that, for example, there is a request from the driver. The switching unit 131 may be configured to execute switching to lower the automation level on the condition that the driver responds to a request from a system on the vehicle side, for example.

When the system of the subject vehicle has a right to control the driving operation, the control execution unit 104 executes acceleration/deceleration control, steering control, and the like of the subject vehicle according to the travel plan determined by the action determination unit 103, in cooperation with the vehicle control ECU 60. The control execution unit 104 executes, for example, ACC (Adaptive Cruise Control) control, LTA (Lane Tracing Assist) control, and LCA (Lane Change Assist) control.

The ACC control is control that allows the subject vehicle to travel at a constant speed that is a set vehicle speed or to execute following traveling to follow a preceding vehicle. In the following traveling, the acceleration/deacceleration control is executed for maintaining a vehicle-to-vehicle distance between the subject vehicle and the nearest preceding vehicle at a target vehicle-to-vehicle distance. The target vehicle-to-vehicle distance may be set depending on the speed of the subject vehicle. The LTA control is control for keeping the subject vehicle traveling in the lane. In the LTA control, steering control is executed so as to keep the subject vehicle traveling in the lane. The LCA control is control for causing the subject vehicle to automatically change lanes from the lane in which the subject vehicle travels to the adjacent lane. In the LCA control, when a trigger for executing the lane change is detected, the lane change is executed by the acceleration/deceleration control and the steering control. The control execution unit 104 executes the automated driving at LV2 or higher by executing both the ACC control and LTA control. The LCA control may be executable, for example, when the ACC control and the LTA control are being executed. The control execution unit 104 may execute the automated driving at LV1 by any one of the ACC control and the LTA control.

The congestion determination unit 105 determines traffic congestion. That is, the congestion determination unit 105 determines presence or absence of the traffic congestion. The processing in the congestion determination unit 105 corresponds to a congestion determination step. The congestion determination unit 105 determines traffic congestion using the speed of the subject vehicle as a condition. The congestion determination unit 105 determines traffic congestion on the conditions that (i) a road type of the road on which the subject vehicle travels is a specific road type in which the congestion automated driving is permitted, (ii) there is a surrounding vehicle including at least a preceding vehicle ahead of the subject vehicle, and (iii) a situation in which the speed of the subject vehicle is equal to or less than a predetermined speed has continued for a first predetermined time or more.

The specific road type in which the congestion automated driving is permitted may be a road type corresponding to the AD area described above. Specific examples of the road type include the expressway and the road exclusive for automobiles. The congestion determination unit 105 may determine whether the road type of the road on which the subject vehicle travels is the specific road type on which the congestion automated driving is permitted, based on the subject vehicle position specified by the locator 20 and the map data acquired from the map DB 30. The congestion determination unit 105 may determine whether there is a surrounding vehicle including at least a preceding vehicle ahead of the subject vehicle, based on the detection result of the surrounding vehicle detection unit 121. The congestion determination unit 105 may determine whether the situation in which the speed of the subject vehicle is equal to or less than the predetermined speed has continued for the first predetermined time or more, based on the speed of the subject vehicle sequentially acquired by the speed acquisition unit 101. The predetermined speed may be a low speed from which it is estimated that there is a possibility of traffic congestion. The first predetermined time is a time for distinguishing temporary deceleration and deceleration due to traffic congestion. The first predetermined time may be several seconds, for example.

According to the above configuration, traffic congestion is determined based on the fact that the situation in which the speed of the subject vehicle is equal to or less than the predetermined speed has continued for the first predetermined time or more. Therefore, it is possible to prevent a temporary change in the vehicle speed from causing determination that traffic congestion is present. In addition, the traffic congestion is determined based also on the fact that the road type of the road on which the subject vehicle travels is the specific road type in which the congestion automated driving is permitted. Therefore, a non-congestion situation is less likely to be erroneously determined as traffic congestion. For example, waiting for a traffic signal on the general road is not erroneously determined as traffic congestion. Further, the traffic congestion is determined based on the presence of the surrounding vehicle including at least the preceding vehicle ahead of the subject vehicle. Therefore, a non-congestion situation is less likely to be erroneously determined as traffic congestion also in this respect. For example, a non-congested situation in which there is no surrounding vehicle including at least a preceding vehicle ahead of the subject vehicle is not erroneously determined as traffic congestion. As a result, it is possible to more accurately determine the traffic congestion which is the condition of the automated driving. The congestion determination unit 105 may be configured to determine that traffic congestion is absent when the situation in which the speed of the subject vehicle is equal to or less than the predetermined speed has not continued for the first predetermined time. According to this, it is possible to prevent a temporary change in the vehicle speed from causing determination that traffic congestion is present. Therefore, it is possible to more accurately determine the traffic congestion which is the condition of the automated driving.

The traffic congestion determination unit 105 may determine traffic congestion also on the condition of a speed difference between the subject vehicle and each of surrounding vehicles including at least a preceding vehicle ahead of the subject vehicle. The congestion determination unit 105 uses the speed difference acquired by the speed difference acquisition unit 123 as the speed difference between the subject vehicle and the surrounding vehicle.

The traffic congestion determination unit 105 may determine traffic congestion also on the condition that the speed difference between the subject vehicle and each of the surrounding vehicles is equal to or less than a threshold value. The surrounding vehicles include the preceding vehicle ahead of the subject vehicle, and the following vehicle behind the subject vehicle or the side vehicle on a lateral side of the subject vehicle. This is because there is a high possibility that both the speed difference between the subject vehicle and the preceding vehicle and the speed difference between the subject vehicle and the following vehicle or the side vehicle are small values in traffic congestion. Therefore, it is possible to more accurately determine traffic congestion. The threshold value referred to here may be a value for classifying a value at which it can be said that there is no speed difference. In other word, the threshold value mentioned here may be a value for distinguishing a situation where there is no speed difference and a situation where there is a certain speed difference between the subject vehicle and a surrounding vehicle.

The traffic congestion determination unit 105 may determine traffic congestion also on the condition that the speed difference between the subject vehicle and the preceding vehicle increases earlier than increase of the speed difference between the subject vehicle and the following vehicle or the side vehicle. This condition may be a condition that an increase rate of the speed difference between the subject vehicle and the preceding vehicle is higher than an increase rate of the speed difference between the subject vehicle and the following vehicle or the side vehicle. In a situation in which the inter-vehicle distance is narrow in traffic congestion, there is a high possibility that the speed difference between the subject vehicle and the preceding vehicle increases earlier than increase of the speed difference between the subject vehicle and the following vehicle or the side vehicle because the following vehicle follows the behavior of the preceding vehicle. Therefore, it is possible to more accurately determine traffic congestion. The congestion determination unit 105 may determine traffic congestion on the condition that the speed difference between the subject vehicle and the preceding vehicle is earlier than increase of the speed difference between the subject vehicle and the following vehicle or the side vehicle when the speed difference between the subject vehicle and the preceding vehicle and the speed difference between the subject vehicle and the following vehicle or the side vehicle decreases to become equal to or less than the threshold value. According to this, it is possible to more accurately determine traffic congestion.

The congestion determination unit 105 may determine that traffic congestion is present on a condition that an amount of change in speed of the subject vehicle with respect to a second predetermined time is within a predetermined amount of change, and determine that traffic congestion is absent on a condition that the amount of change in speed of the subject vehicle with respect to the second predetermined time is not within the predetermined amount of change. This is because there is a high possibility that the amount of change in speed of the subject vehicle is small during traffic congestion. The congestion determination unit 105 may determine whether the amount of change in speed of the subject vehicle with respect to the second predetermined time is within the predetermined amount of change based on the speed of the subject vehicle sequentially acquired by the speed acquisition unit 101. The predetermined amount of change may be a small value from which it is estimated that there is a possibility of traffic congestion. The amount of change may employ a deviation from a reference value such as an average value or a median value. Hereinafter, a case where the deviation is used will be described as an example. The amount of change in speed of the subject vehicle may be acceleration/deceleration of the subject vehicle. The second predetermined time is a time that can be arbitrarily set, and may be, for example, 3 seconds. The second predetermined time may be the same as the first predetermined time.

The congestion determination unit 105 may determine both occurrence of traffic congestion and resolution of traffic congestion in the determination of traffic congestion. Regarding the occurrence of traffic congestion, the determination of traffic congestion by the congestion determination unit 105 corresponds to determination of the occurrence of traffic congestion. On the other hand, the determination of no traffic congestion by the congestion determination unit 105 corresponds to determination of no occurrence of traffic congestion. Regarding the resolution of traffic congestion, the determination of traffic congestion by the traffic congestion determination unit 105 corresponds to determination of no resolution of traffic congestion. On the other hand, the determination of no traffic congestion by the congestion determination unit 105 corresponds to determination of the resolution of traffic congestion.

Regarding the determination of occurrence of traffic congestion, the congestion determination unit 105 may use the fact that the amount of change in speed of the subject vehicle with respect to the second predetermined time is within the predetermined amount of change as a condition for the occurrence of traffic congestion. On the other hand, regarding the resolution of traffic congestion, the congestion determination unit 105 may not use the fact that the amount of change in speed of the subject vehicle with respect to the second predetermined time is not within the predetermined amount of change as a condition for the resolution of traffic congestion. The amount of change in speed of the subject vehicle is unnecessary for the determination of resolution of traffic congestion because it is possible to accurately determine the resolution of traffic congestion by using large increase in speed of the subject vehicle when the traffic congestion is resolved.

In the congestion determination unit 105, at least one of the predetermined speed and the first predetermined time may be different between determination of traffic congestion for the automated driving at the congestion-only LV3 and determination of traffic congestion for the automated driving at the congestion-only LV2. In the congestion determination unit 105, the predetermined speed may be lower and/or the first predetermined time may be longer in the determination of traffic congestion for the automated driving at the congestion-only LV3 than in the determination of traffic congestion for the automated driving at the congestion-only LV2. Accordingly, reliability of the determination of traffic congestion for the automated driving at the congestion-only LV3 can be increased as compared with the determination of traffic congestion for the automated driving at the congestion-only LV2. More specifically, since the automated driving at the congestion-only LV3 is automated driving without the surrounding monitoring obligation, the driver needs more time and effort to change the driver's response at the time of lowering the automation level in the automated driving at the congestion-only LV3 than in the automated driving at the congestion-only LV2. Therefore, the automated driving at the congestion-only LV3 may be prevented from being started under a condition that the determination of traffic congestion is easily changed, thereby reducing the driver's time and effort.

For example, the predetermined speed in the determination of traffic congestion for the automated driving at the congestion-only LV3 may be 25 km/h, and the predetermined speed in the determination of traffic congestion for the automated driving at the congestion-only LV2 may be 30 km/h. For example, the first predetermined time in the determination of traffic congestion for the automated driving at the congestion-only LV3 may be 4 seconds, and the first predetermined time in the determination of traffic congestion for the automated driving at the congestion-only LV2 may be 3 seconds. Hereinafter, the predetermined speed in the determination of traffic congestion for the automated driving at the congestion-only LV3 is referred to as an LV3 predetermined speed. Hereinafter, the predetermined speed in the determination of traffic congestion for the automated driving at the congestion-only LV2 is referred to as an LV2 predetermined speed. Hereinafter, the first predetermined time in the determination of traffic congestion for the automated driving at the congestion-only LV3 is referred to as an LV3 first predetermined time. Hereinafter, the first predetermined time in the determination of traffic congestion for the automated driving at the congestion-only LV2 is referred to as an LV2 first predetermined time.

In the traffic congestion determination unit 105, the first predetermined time may be the same for both the determination of occurrence of traffic congestion and the determination of resolution of traffic congestion. Accordingly, it is possible to eliminate a deviation in determination criteria between the determination of occurrence of traffic congestion and the determination of resolution of traffic congestion. Therefore, it is possible to reduce discomfort due to great difference of the timing of switching the automation level between the determination of occurrence of traffic congestion and the determination of resolution of traffic congestion. Here, the same in time may not be completely the same, and may be substantially the same including a deviation of an error degree.

The congestion determination unit 105 may relax the conditions for presence of traffic congestion when (i) the road type of the road on which the subject vehicle travels is a specific road type in which the congestion automated driving is permitted and (ii) lighting of the hazard light of the preceding vehicle ahead of the subject vehicle is detected. In a situation in which the preceding vehicle is turning on the hazard light on the road of the road type for which the congestion automated driving is permitted, there is a very high possibility that the preceding vehicle is informing of traffic congestion by turning on the hazard light. Therefore, even if the conditions for presence of traffic congestion are relaxed, there is a high possibility that traffic congestion can be accurately determined.

The congestion determination unit 105 may determine whether the lighting of the hazard light of the preceding vehicle in front of the subject vehicle has been detected based on the detection result of the hazard light detection unit 122. The conditions for presence of traffic congestion may be relaxed by changing the predetermined speed to a higher speed. The conditions for presence of traffic congestion may be relaxed by changing the first predetermined time to a shorter time.

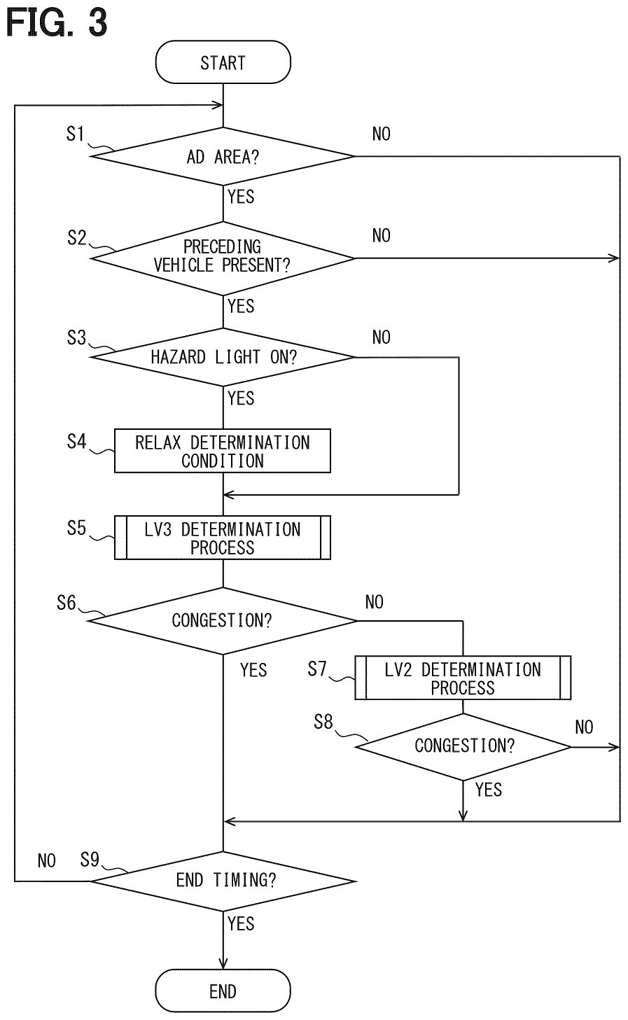

Here, an example of a flow of a process (hereinafter, a congestion determination-related process) related to the congestion determination in the automated driving ECU 10 will be described with reference to flowcharts of FIGS. 3 to 5. The flowchart shown in FIG. 3 may start, for example, if a switch (hereinafter, referred to as a power switch) for starting an internal combustion engine or a motor generator of the subject vehicle is turned on. In addition, if the automated driving function can be switched on and off, a situation where the automated driving function is on may be added to the condition for starting the process.

First, in step S1, the congestion determination unit 105 determines whether the road type of the road on which the subject vehicle travels is the specific road type in which the congestion automated driving is permitted. Here, it is assumed that the specific road type is a road type corresponding to the AD area. In S1, when the road type of the road on which the subject vehicle travels corresponds to the AD area (YES in S1), the process proceeds to S2. On the other hand, when the road type of the road on which the subject vehicle travels does not correspond to the AD area (NO in S1), the process proceeds to step S9. A condition in which the road type of the road on which the subject vehicle travels is the specific road type in which the congestion automated driving is permitted is hereinafter referred to as a road type condition.

In step S2, when the surrounding vehicle detection unit 121 detects presence of at least a preceding vehicle in front of the subject vehicle (YES in S2), the process proceeds to step S3. On the other hand, when the surrounding vehicle detection unit 121 cannot detect the presence of a preceding vehicle in front of the subject vehicle (NO in S2), the process proceeds to step S9. A condition in which a surrounding vehicle is present around the subject vehicle is hereinafter referred to as a surrounding vehicle condition.

In step S3, when the hazard light detection unit 122 detects lighting of the hazard light of the preceding vehicle in front of the subject vehicle (YES in S3), the process proceeds to step S4. On the other hand, when the hazard light detection unit 122 does not detect lighting of the hazard light of the preceding vehicle in front of the subject vehicle (NO in S3), the process proceeds to step S5.

In step S4, the congestion determination unit 105 relaxes the condition for determining traffic congestion. The congestion determination unit 105 may relax the condition compared to the default condition. For example, this switching may be executed in a following manner. By default, the LV3 predetermined speed may be 25 km/h, and the LV3 first predetermined time may be 4 seconds. By default, the LV2 predetermined speed may be 30 km/h, and the LV2 first predetermined time may be 3 seconds. When the condition is relaxed, for example, the LV3 predetermined speed may be 30 km/h, and the LV3 first predetermined time may be 3 seconds. When the condition is relaxed, for example, the LV2 predetermined speed may be 35 km/h, and the LV2 first predetermined time may be 2 seconds.

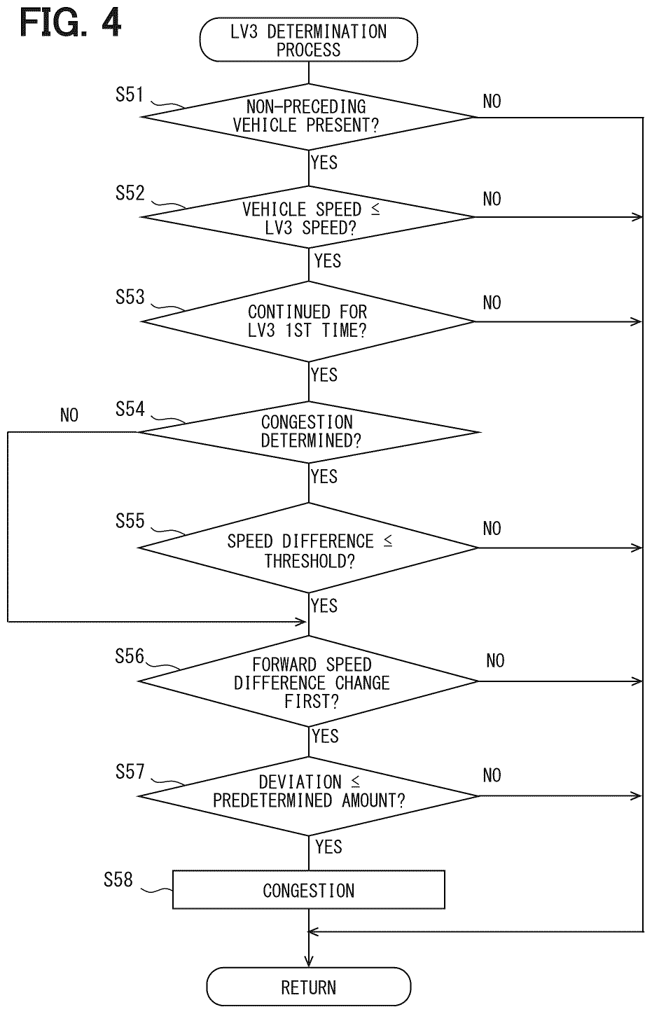

In step S5, LV3 determination process is executed, and the process proceeds to step S6. Here, an example of a flow of the LV3 determination process will be described with reference to the flowchart of FIG. 4.

First, in step S51, when the surrounding vehicle detection unit 121 detects presence of a non-preceding surrounding vehicle such as a following vehicle or a side vehicle in addition to the preceding vehicle (YES in S51), the process proceeds to step S52. On the other hand, when the presence of the non-preceding surrounding vehicle cannot be detected (NO in S51), the process proceeds to step S6. The surrounding vehicle condition also includes a condition regarding presence of a non-preceding surrounding vehicle other than the preceding vehicle preceding the subject vehicle.

In step S52, the congestion determination unit 105 determines whether the speed of the subject vehicle is equal to or less than the LV3 predetermined speed. When the speed of the subject vehicle acquired by the speed acquisition unit 101 is equal to or lower than the LV3 predetermined speed (YES in S52), the process proceeds to step S53. On the other hand, when the speed of the subject vehicle exceeds the LV3 predetermined speed (NO in S52), the process proceeds to step S6. In S52, when the condition of the predetermined speed is relaxed in S4, the congestion determination unit 105 may determine whether the relaxed condition is satisfied. Hereinafter, a condition in which the speed of the subject vehicle is equal to or less than the predetermined speed is referred to as a speed condition.

In step S53, the congestion determination unit 105 determines whether a situation in which the speed of the subject vehicle is equal to or less than the LV3 predetermined speed has continued for the LV3 first predetermined time or more. In other words, the congestion determination unit 105 determines whether the LV3 predetermined time has elapsed since the speed of the subject vehicle becomes less than or equal to the LV3 predetermined speed. When the situation in which the speed of the subject vehicle is equal to or less than the LV3 predetermined speed is determined to have continued for the LV3 first predetermined time or more (YES in S53), the process proceeds to step S54. On the other hand, when the situation in which the speed of the subject vehicle is equal to or less than the LV3 predetermined speed has not continued for the LV3 first predetermined time (NO in S53), the process proceeds to step S6. Also in S53, when the condition of the first predetermined time has been relaxed in S4, the congestion determination unit 105 may determine whether the relaxed condition is satisfied. Hereinafter, a condition in which the situation in which the speed of the subject vehicle is equal to or less than the predetermined speed has continued for the first predetermined time or more is referred to as a continuation time condition.

In step S54, when the congestion determination unit 105 has already determined that traffic congestion is present, i.e. the traffic congestion has been determined (YES in S54), the process proceeds to step S55. The case where the traffic congestion has been determined corresponds to a case where resolution of traffic congestion is determined in a state where it has already been determined that the traffic congestion is present. On the other hand, when the traffic congestion has not been determined (NO in S54), the process proceeds to step S56. The case where the traffic congestion has not been determined corresponds to a case where occurrence of traffic congestion is determined in a state where it has not been determined that the traffic congestion is present.

In step S55, the congestion determination unit 105 determines whether both a speed difference between the preceding vehicle and the subject vehicle and a speed difference between the non-preceding surrounding vehicle and the subject vehicle, which have been acquired by the speed difference acquisition unit 123, are equal to or less than a threshold value. The speed difference between the preceding vehicle and the subject vehicle is hereinafter referred to as a forward speed difference. The speed difference between the non-preceding surrounding vehicle and the subject vehicle is hereinafter referred to as a non-forward speed difference. When both the forward speed difference and the non-forward speed difference are equal to or less than the threshold (YES in S55), the process proceeds to step S56. On the other hand, when the forward speed difference or the non-forward speed difference is larger than the threshold (NO in S55), the process proceeds to step S6. A condition in which both the forward speed difference and the non-forward speed difference are equal to or less than the threshold value is hereinafter referred to as a first speed difference condition.

In step S56, the congestion determination unit 105 determines whether the forward speed difference has changed to increase earlier than increase of the non-forward speed difference. When the forward speed difference has increased earlier than increase of the non-forward speed difference (YES in S56), the process proceeds to step S57. On the other hand, when the forward speed difference has not changed to increase earlier than increase of the non-forward speed difference (NO in S56), the process proceeds to step S6. A condition in which the forward speed difference has changed to increase earlier than increase of the non-forward speed difference is hereinafter referred to as a second speed difference condition.

In step S57, the congestion determination unit 105 determines whether the deviation, which is the amount of change in speed of the subject vehicle with respect to the second predetermined time, is within the predetermined amount of change. When the deviation is within the predetermined amount of change (YES in S57), the process proceeds to step S58. On the other hand, when the deviation is not within the predetermined amount of change (NO in S57), the process proceeds to step S6. A condition in which the amount of change in speed of the subject vehicle with respect to the second predetermined time is within the predetermined amount of change is hereinafter referred to as a change amount condition. In step S58, the congestion determination unit 105 determines that traffic congestion for the automated driving at the congestion-only LV3 is present, and the process proceeds to step S6.

Returning to FIG. 3, when traffic congestion is determined to be present in S5, the traffic congestion for the automated driving at the congestion-only LV3 is determined to be present in S6, and then the process proceeds to step S9. When the traffic congestion for the automated driving at the congestion-only LV3 is determined to be present, execution of the automated driving at the congestion-only LV3 is permitted. On the other hand, when the traffic congestion is determined to be absent in S5, the process proceeds to step S7.

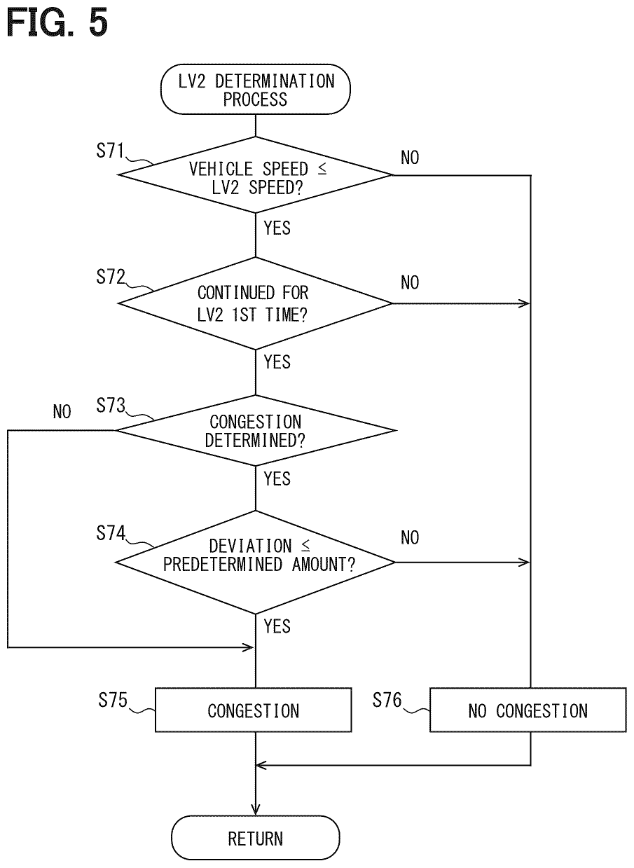

In step S7, LV2 determination process is executed, and the process proceeds to step S8. Here, an example of a flow of the LV2 determination process will be described with reference to the flowchart of FIG. 5.

First, in step S71, the congestion determination unit 105 determines whether the speed of the subject vehicle is equal to or less than the LV2 predetermined speed. When the speed of the subject vehicle acquired by the speed acquisition unit 101 is equal to or lower than the LV2 predetermined speed (YES in S71), the process proceeds to step S72. On the other hand, when the speed of the subject vehicle exceeds the LV2 predetermined speed (NO in S71), the process proceeds to step S76. In S71, when the condition of the predetermined speed is relaxed in S4, the congestion determination unit 105 may determine whether the relaxed condition is satisfied. The speed condition also includes a condition in which the speed of the subject vehicle is equal to or lower than the LV2 predetermined speed.

In step S72, the congestion determination unit 105 determines whether a situation in which the speed of the subject vehicle is equal to or less than the LV2 predetermined speed has continued for the LV2 first predetermined time or more. In other words, the congestion determination unit 105 determines whether the LV2 predetermined time has elapsed since the speed of the subject vehicle becomes less than or equal to the LV2 predetermined speed. When the situation in which the speed of the subject vehicle is equal to or less than the LV2 predetermined speed is determined to have continued for the LV2 first predetermined time or more (YES in S72), the process proceeds to step S73. On the other hand, when the situation in which the speed of the subject vehicle is equal to or less than the LV2 predetermined speed has not continued for the LV2 first predetermined time (NO in S72), the process proceeds to step S76. Also in S72, when the condition of the first predetermined time has been relaxed in S4, the congestion determination unit 105 may determine whether the relaxed condition is satisfied. The continuation time condition includes a condition in which the situation in which the speed of the subject vehicle is equal to or less than the LV2 predetermined speed has continued for the LV2 first predetermined time or more.

In step S73, similar to step S54, when the congestion determination unit 105 has already determined that traffic congestion is present, i.e. the traffic congestion has been determined (YES in S73), the process proceeds to step S74. On the other hand, when the traffic congestion has not been determined (NO in S73), the process proceeds to step S75.

In step S74, the congestion determination unit 105 determines whether the deviation, which is the amount of change in speed of the subject vehicle with respect to the second predetermined time, is within the predetermined amount of change. When the deviation is within the predetermined amount of change (YES in S74), the process proceeds to step S75. On the other hand, when the deviation is not within the predetermined amount of change (NO in S74), the process proceeds to step S76.

Not only the predetermined speed and the first predetermined time, but also the predetermined amount of change and/or the second predetermined time may have stricter conditions in the determination of traffic congestion for the automated driving at the congestion-only LV3 than in the determination of traffic congestion for the automated driving at the congestion-only LV2. The stricter conditions means conditions in which the predetermined amount of change is a smaller value and the second predetermined time is a longer time. In addition, the condition of the predetermined amount of change and/or the second predetermined time may be relaxed in step S4.

In step S75, the congestion determination unit 105 determines that traffic congestion for the automated driving at the congestion-only LV2 is present, and the process proceeds to step S9. On the other hand, in step S76, the congestion determination unit 105 determines that traffic congestion is absent, and the process proceeds to step S9. When the traffic congestion for the automated driving at the congestion-only LV2 is determined to be present, execution of the automated driving at the congestion-only LV2 is permitted. On the other hand, when it is determined that there is no traffic congestion, neither execution of the automated driving at the congestion-only LV3 nor execution of the automated driving at the congestion-only LV2 is permitted.

Returning to FIG. 3, in step S9, when it is the end timing of the congestion determination-related process (YES in S9), the congestion determination-related process is ended. On the other hand, when it is not the end timing of the congestion determination-related process (NO in S9), the process returns to S1 to repeat the process. Examples of the end timing of the congestion determination-related process include a timing when the power switch is turned off and a timing when the automated driving function is turned off.

In the first embodiment, a configuration has been described in which the condition for presence of traffic congestion is relaxed when the hazard light detection unit 122 detects lighting of a hazard light of a preceding vehicle in front of the subject vehicle, but the present invention is not necessarily limited thereto. For example, the processes of steps S3 and S4 may be omitted.

In the first embodiment, the conditions used in the determination of traffic congestion for the automated driving at the congestion-only LV3 is stricter than the conditions used in the determination of traffic congestion for the automated driving at the congestion-only LV2, but the present invention is not necessarily limited thereto. For example, the strictness of the conditions may be the same between the determination of traffic congestion for the automated driving at the congestion-only LV3 and the determination of traffic congestion for the automated driving at the congestion-only LV2. In this case, determination whether the conditions other than the surrounding vehicle condition are satisfied may be a common process between the determination of traffic congestion for the automated driving at the congestion-only LV3 and the determination of traffic congestion for the automated driving at the congestion-only LV2.

In the first embodiment, even if the road type condition, the speed condition, the surrounding vehicle condition, and the continuation time condition are satisfied, traffic congestion may be determined to be absent, but the present invention is not necessarily limited thereto. For example, if the road type condition, the speed condition, the surrounding vehicle condition, and the continuation time condition are satisfied, it may be determined that there is traffic congestion. In this case, the processes for the first speed difference condition, the second speed difference condition, and the change amount condition may be omitted.

In the first embodiment, the determination whether one or more of conditions: the first speed difference condition, the second speed difference condition and the change amount condition, are satisfied may be omitted.

In the first embodiment, it is determined that traffic congestion is absent unless the continuation time condition is satisfied, but the present invention is not necessarily limited thereto. Even when the continuation time condition is not satisfied, it may be determined that there is traffic congestion. For example, even if the continuation time condition is not satisfied, when other conditions such as the first speed difference condition, the second speed difference condition, and the change amount condition are satisfied by a specified number or more, it is determined that traffic congestion is present.

In the flowchart of FIG. 3, the determination whether one or more of conditions: the first speed difference condition, the second speed difference condition and the change amount condition, are satisfied may be omitted.

In the first embodiment, the situation in which the road type condition, the speed condition, the surrounding vehicle condition, and the continuation time condition are satisfied is essential for the presence of traffic congestion, but the present invention is not necessarily limited thereto. For example, the determination whether the continuation time condition is satisfied may be omitted.

For example, the determination of whether the road type condition, the speed condition, the surrounding vehicle condition, and the first speed difference condition and/or the second speed condition are satisfied may be essential for the presence of traffic congestion. That is, the congestion determination unit 105 may be configured to determine traffic congestion on the basis of the conditions that (i) the road type of the road on which the subject vehicle travels is the specific road type in which the congestion automated driving is permitted, and (ii) the there is a surrounding vehicle including at least a preceding vehicle ahead of the subject vehicle, and also on the basis of the speed difference between the subject vehicle and each of surrounding vehicles including at least a vehicle ahead of the subject vehicle. Further, the traffic congestion determination unit 105 may be configured to determine that traffic congestion is absent when the speed difference between the subject vehicle and the preceding vehicle ahead of the subject vehicle and the speed difference between the subject vehicle and the following vehicle behind the subject vehicle or the side vehicle on the lateral side of the subject vehicle are both not equal to or less than the threshold value. In addition, the traffic congestion determination unit 105 may be configured to determine that traffic congestion is absent unless the speed difference between the subject vehicle and the preceding vehicle in front of the subject vehicle changes to increase earlier than increase of the speed difference between the subject vehicle and the following vehicle or the side vehicle.

For example, the determination whether the road type condition, the speed condition, the surrounding vehicle condition, and the change amount condition are satisfied may be an essential configuration for the determination of traffic congestion. That is, the congestion determination unit 105 may be configured to determine traffic congestion on the conditions that (i) the road type of the road on which the subject vehicle travels is the specific road type in which the congestion automated driving is permitted, (ii) the there is a surrounding vehicle including at least a preceding vehicle ahead of the subject vehicle, and (iii) the amount of change in speed of the subject vehicle with respect to the second predetermined time is within the predetermined amount of change. In addition, the congestion determination unit 105 may be configured to determine that traffic congestion is absent if the amount of change in speed of the subject vehicle with respect to the second predetermined time is not within the predetermined amount of change.

### Second Embodiment

In the first embodiment, the automated driving ECU 10 includes the speed acquisition unit 101, the surrounding vehicle detection unit 121, the hazard light detection unit 122, the speed difference acquisition unit 123, and the congestion determination unit 105. However, the present invention is not necessarily limited thereto. The functions of the speed acquisition unit 101, the surrounding vehicle detection unit 121, the hazard light detection unit 122, the speed difference acquisition unit 123, and the congestion determination unit 105 may be executed by an ECU used in a vehicle other than the automated driving ECU 10. In this case, the surrounding vehicle detection unit 121 may identify presence of a surrounding vehicle around the subject vehicle based on an traveling environment recognized by the traveling environment recognition unit 102 of the automated driving ECU 10. The hazard light detection unit 122 may detect lighting of a hazard light of a preceding vehicle in front of the subject vehicle based on the travel environment recognized by the traveling environment recognition unit 102 of the automated driving ECU 10. The speed difference acquisition unit 123 may acquire the speed difference between the subject vehicle and the surrounding vehicle that has been detected based on the travel environment recognized by the traveling environment recognition unit 102 of the automated driving ECU 10.

The present disclosure is not limited to the embodiments described above, and various modifications are possible within the scope of the claims. An embodiment obtained by appropriately combining technical means disclosed in different embodiments is also included in the technical scope of the present disclosure. The control device and the control method described in the present disclosure may be implemented by a special purpose computer which includes a processor programmed to execute one or more functions executed by computer programs. Alternatively, the devices and methods described in the present disclosure may be fully implemented by special purpose logical hardware logic circuits. Further alternatively, the devices and methods described in the present disclosure may be implemented by a special purpose computer created by a combination of a processor executing computer programs coupled with hardware logic circuits. The computer program may also be stored in a computer-readable non-transitory tangible storage medium as instructions to be executed by a computer.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A vehicle control device configured to be used in a subject vehicle configured to execute congestion automated driving, the congestion automated driving being automated driving permitted in traffic congestion, the vehicle control device comprising:
at least one processor; and
at least one memory storing a program configured to, when executed by the at least one processor, cause the at least one processor to carry out:
determining traffic congestion based on a speed of the subject vehicle used as a condition; and
switching between execution and non-execution of the congestion automated driving in accordance with a determination result of the determining, wherein
the determining includes determining that traffic congestion is present on conditions including
a condition that a road type of a road on which the subject vehicle travels is a specific road type in which the congestion automated driving is permitted,
a condition that there is at least one surrounding vehicle including a preceding vehicle ahead of the subject vehicle, and
a condition that a situation in which the speed of the subject vehicle is equal to or less than a predetermined speed has continued for a first predetermined time or more.

2. The vehicle control device according to claim 1, wherein
the conditions further include a speed difference between the subject vehicle and each of surrounding vehicles including the preceding vehicle.

3. The vehicle control device according to claim 2, wherein
the conditions further include a condition that a speed difference between the subject vehicle and the preceding vehicle and a speed difference between the subject vehicle and a following vehicle behind the subject vehicle or a side vehicle on a lateral side of the subject vehicle are less than or equal to a threshold value.

4. The vehicle control device according to claim 2, wherein
the conditions further include a condition that a speed difference between the subject vehicle and the preceding vehicle increases earlier than increase of a speed difference between the subject vehicle and a following vehicle behind the subject vehicle or a side vehicle on a lateral side of the subject vehicle.

5. A vehicle control device configured to be used in a subject vehicle configured to execute congestion automated driving, the congestion automated driving being automated driving permitted in traffic congestion, the vehicle control device comprising:
at least one processor; and
at least one memory storing a program configured to, when executed by the at least one processor, cause the at least one processor to carry out:
determining traffic congestion based on a speed of the subject vehicle used as a condition; and
switching between execution and non-execution of the congestion automated driving in accordance with a determination result of the determining, wherein
the determining includes determining that traffic congestion is absent on a condition that a situation in which the speed of the vehicle is equal to or less than a predetermined speed has not continued for a first predetermined time.

6. The vehicle control device according to claim 1, wherein
the conditions include a condition that an amount of change in the speed of the vehicle with respect to a second predetermined time is within a predetermined amount of change, and
the determining further includes determining that traffic congestion is absent on a condition that the amount of change in the speed of the vehicle with respect to the second predetermined time is not within the predetermined amount of change.

7. The vehicle control device according to claim 6, wherein
the amount of change in the speed of the subject vehicle is a deviation from a reference value of the speed of the subject vehicle.

8. The vehicle control device according to claim 6, wherein
the determining further includes
determining occurrence of traffic congestion on the condition that the amount of change in the speed of the subject vehicle with respect to the second predetermined time is within the predetermined amount of change, and
determining resolution of traffic congestion without using the condition that the amount of change in the speed of the subject vehicle with respect to the second predetermined time is not within the predetermined amount of change.

9. The vehicle control device according to claim 1, wherein
the congestion automated driving includes
congestion automated driving without a monitoring obligation being imposed on a driver of the subject vehicle, and
congestion automated driving with the monitoring obligation being imposed on the driver of the subject vehicle, and
at least one of the predetermined speed or the first predetermined time is different between determination of traffic congestion that is a condition for the congestion automated driving without the monitoring obligation and determination of traffic congestion that is a condition for the congestion automated driving with the monitoring obligation.

10. The vehicle control device according to claim 9, wherein
the predetermined speed is lower and/or the first predetermined time is longer in the determination of traffic congestion that is the condition for the congestion automated driving without the monitoring obligation than in the determination of traffic congestion that is the condition for the congestion automated driving with the monitoring obligation.

11. The vehicle control device according to claim 1, wherein
the determining further includes determining occurrence of traffic congestion and resolution of traffic congestion, and
the first predetermined time is same for both determination of the occurrence of traffic congestion and determination of the resolution of traffic congestion.

12. The vehicle control device according to claim 1, wherein
the determining further includes relaxing the conditions for traffic congestion when (i) the road type of the road on which the subject vehicle travels is the specific road type in which the congestion automated driving is permitted and (ii) lighting of a hazard light of the preceding vehicle ahead of the subject vehicle is detected.

13. A vehicle control method used in a subject vehicle configured to execute congestion automated driving and executed by at least one processor, the congestion automated driving being automated driving permitted in traffic congestion, the method comprising:
determining traffic congestion based on a speed of the subject vehicle used as a condition; and
switching between execution and non-execution of the congestion automated driving in accordance with a determination result of the determining, wherein
the determining includes determining that traffic congestion is present on conditions including
a condition that a road type of a road on which the subject vehicle travels is a specific road type in which the congestion automated driving is permitted,
a condition that there is at least one surrounding vehicle including a preceding vehicle ahead of the subject vehicle, and
a condition that a situation in which the speed of the subject vehicle is equal to or less than a predetermined speed has continued for a first predetermined time or more.

14. A vehicle control method used in a subject vehicle configured to execute congestion automated driving and executed by at least one processor, the congestion automated driving being automated driving permitted in traffic congestion, the method comprising:
determining traffic congestion based on a speed of the subject vehicle used as a condition; and
switching between execution and non-execution of the congestion automated driving in accordance with a determination result of the determining, wherein
the determining includes determining that traffic congestion is absent on a condition that a situation in which the speed of the vehicle is equal to or less than a predetermined speed has not continued for a first predetermined time.
